(19) United States
(12) Patent Application Publication
(10) Pub. No.: US 2023/0104208 A1
(43) Pub. Date: Apr. 6, 2023

(54) SYSTEM AND METHOD FOR FRAUD DETECTION USING MACHINE LEARNING TECHNOLOGY

(71) Applicant: Visa International Service Association, San Francisco, CA (US)

(72) Inventors: Navendu Misra, Austin, TX (US); Nazmiye Ceren Abay, Kirkland, WA (US); Akon Samir Dey, Foster City, CA (US); Rajan Gangadharan, Campbell, CA (US); Durga Kala, Cupertino, CA (US)

(73) Assignee: Visa International Service Association, San Francisco, CA (US)

(21) Appl. No.: 17/495,114

(22) Filed: Oct. 6, 2021

(51) Int. Cl. G06Q 20/40

(52) U.S. Cl. CPC G06Q 20/4016; G06Q 20/405; G06Q 20/407

(57) ABSTRACT

A computer-implemented method includes, receiving, with at least one processor, payment transaction data, extracting, using the at least one processor, catastrophic event data from a network, generating, with the at least one processor, a catastrophic event score based on the payment transaction data and the catastrophic event data, and adjusting financial fraud rules used to decline or approve financial transactions. The financial fraud rules may be adjusted by adding a catastrophic event threshold to the financial fraud rules that utilize the catastrophic event score to determine whether a financial transaction is fraudulent.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Electronic payments systems are critical to the financial infrastructure of modern financial systems. As a result, when a person, merchant, or financial institution is unable to process financial transactions during critical situations, such as, for example, extreme weather conditions or the like, then the lack of access to the financial instruments required to purchase necessities negatively affects the personal and business conditions of the individual, merchant, and financial institution. Furthermore, since individuals and merchants are not able to purchase essential necessities during such extreme events, the financial institutions may be viewed negatively since they are not able to provide the much-needed access to the financial instruments required for survival. Therefore, a need exists to create electronic payment systems that operate effectively under varying circumstances.

### BRIEF DESCRIPTION OF THE DRAWINGS

FIG. 1 is a diagram of non-limiting embodiments or aspects of an environment in which systems, devices, products, apparatus, and/or methods, described herein, may be implemented;

FIG. 2 is a diagram of non-limiting embodiments or aspects of components of one or more devices and/or one or more systems of FIG. 1;

FIG. 3 is a diagram of non-limiting embodiments or aspects of components of one or more devices and/or one or more systems of FIG. 1; and

FIG. 4 is a flowchart of non-limiting embodiments or aspects of a process for fraud detection used in one or more devices and/or one or more systems of FIG. 1.

### DETAILED DESCRIPTION

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

It will be apparent that systems and/or methods, described herein, can be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code, it being understood that software and hardware can be designed to implement the systems and/or methods based on the description herein.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

As used herein, the term “transaction service provider” may refer to an entity that receives transaction authorization requests from merchants or other entities and provides guarantees of payment, in some cases through an agreement between the transaction service provider and an issuer institution. The terms “transaction service provider” and “transaction service provider system” may also refer to one or more computer systems operated by or on behalf of a transaction service provider, such as a transaction processing system executing one or more software applications. A transaction processing system may include one or more server computers with one or more processors and, in some non-limiting embodiments or aspects, may be operated by or on behalf of a transaction service provider.

As used herein, the term “account identifier” may include one or more Primary Account Numbers (PAN), tokens, or other identifiers (e.g., a globally unique identifier (GUID), a universally unique identifier (UUID), etc.) associated with a customer account of a user (e.g., a customer, a consumer, and/or the like). The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more databases such that they can be used to conduct a transaction without directly using the original account identifier. In some examples, an original account identifier, such as a PAN, may be associated with a plurality of tokens for different individuals or purposes.

As used herein, the terms “issuer institution,” “portable financial device issuer,” “issuer,” or “issuer bank” may refer to one or more entities that provide one or more accounts to a user (e.g., a customer, a consumer, an entity, an organization, and/or the like) for conducting transactions (e.g., payment transactions), such as initiating credit card payment transactions and/or debit card payment transactions. For example, an issuer institution may provide an account identifier, such as a PAN, to a user that uniquely identifies one or more accounts associated with that user. The account identifier may be embodied on a portable financial device, such as a physical financial instrument (e.g., a payment card), and/or may be electronic and used for electronic payments. In some non-limiting embodiments or aspects, an issuer institution may be associated with a bank identification number (BIN) that uniquely identifies the issuer institution. As used herein “issuer institution system” may refer to one or more computer systems operated by or on behalf of an issuer institution, such as a server computer executing one or more software applications. For example, an issuer institution system may include one or more authorization servers for authorizing a payment transaction.

As used herein, the term “merchant” may refer to an individual or entity that provides products and/or services, or access to products and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system,” as used herein, may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction.

As used herein, the term “mobile device” may refer to one or more portable electronic devices configured to communicate with one or more networks. As an example, a mobile device may include a cellular phone (e.g., a smartphone or standard cellular phone), a portable computer (e.g., a tablet computer, a laptop computer, etc.), a wearable device (e.g., a watch, pair of glasses, lens, clothing, and/or the like), a personal digital assistant (PDA), and/or other like devices. The terms “client device” and “user device,” as used herein, refer to any electronic device that is configured to communicate with one or more servers or remote devices and/or systems. A client device or user device may include a mobile device, a network-enabled appliance (e.g., a network-enabled television, refrigerator, thermostat, and/or the like), a computer, a POS system, and/or any other device or system capable of communicating with a network.

As used herein, the term “computing device” or “computer device” may refer to one or more electronic devices that are configured to directly or indirectly communicate with or over one or more networks. The computing device may be a mobile device, a desktop computer, or the like. Furthermore, the term “computer” may refer to any computing device that includes the necessary components to receive, process, and output data, and normally includes a display, a processor, a memory, an input device, and a network interface. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, touchscreen, etc.).

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Wallet™, Android Pay®, Apple Pay®, Samsung Pay®, and/or other like electronic payment systems. In some non-limiting examples, an issuer bank may be an electronic wallet provider.

As used herein, the term “portable financial device” may refer to a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a mobile device executing an electronic wallet application, a personal digital assistant (PDA), a security card, an access card, a wireless terminal, and/or a transponder, as examples. The portable financial device may include a volatile or a non-volatile memory to store information, such as an account identifier and/or a name of the account holder.

As used herein, the term “server” may refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, such as POS devices, directly or indirectly communicating in the network environment may constitute a “system,” such as a merchant's POS system.

As used herein, the term “acquirer” may refer to an entity licensed by the transaction service provider and/or approved by the transaction service provider to originate transactions using a portable financial device of the transaction service provider. Acquirer may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

In some embodiments, Visa Risk Manager (VRM) refers to a portal that is configured to assist issuers with fraud loss prevention by providing clients with a transaction risk management decisioning system and/or catastrophic-event-based fraud detection system.

Provided are improved systems, devices, products, apparatus, and/or methods for fraud detection.

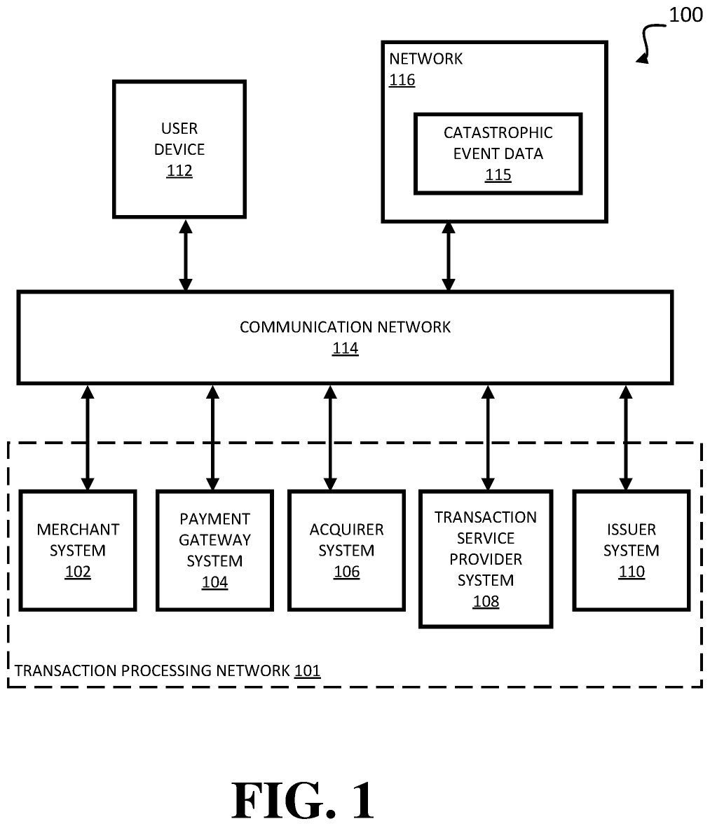

Referring now to FIG. 1, FIG. 1 is a diagram of an example environment 100 in which devices, systems, methods, and/or products described herein, may be implemented. As shown in FIG. 1, environment 100 includes transaction processing network 101, which may include merchant system 102, payment gateway system 104, acquirer system 106, transaction service provider system 108, and/or issuer system 110, user device 112, communication network 114, and/or network system 116. Transaction processing network 101, merchant system 102, payment gateway system 104, acquirer system 106, transaction service provider system 108, issuer system 110, user device 112, and/or network system 116 may interconnect (e.g., establish a connection to communicate, etc.) via wired connections, wireless connections, or a combination of wired and wireless connections.

Merchant system 102 may include one or more devices capable of receiving information and/or data from payment gateway system 104, acquirer system 106, transaction service provider system 108, issuer system 110, user device 112, and/or network system 116 (e.g., via communication network 114, etc.) and/or communicating information and/or data to payment gateway system 104, acquirer system 106, transaction service provider system 108, issuer system 110, user device 112, and/or network system 116 (e.g., via communication network 114, etc.). Merchant system 102 may include a device capable of receiving information and/or data from user device 112 via a communication connection (e.g., an NFC communication connection, an RFID communication connection, a Bluetooth® communication connection, etc.) with user device 112, and/or communicating information and/or data to user device 112 via the communication connection. For example, merchant system 102 may include a computing device, such as a server, a group of servers, a client device, a group of client devices, and/or other like devices. In some non-limiting embodiments or aspects, merchant system 102 may be associated with a merchant as described herein. In some non-limiting embodiments or aspects, merchant system 102 may include one or more devices, such as computers, computer systems, and/or peripheral devices capable of being used by a merchant to conduct a payment transaction with a user. For example, merchant system 102 may include a POS device and/or a POS system.

In some embodiments, payment gateway system 104 may include one or more devices capable of receiving information and/or data from merchant system 102, acquirer system 106, transaction service provider system 108, issuer system 110, user device 112, and/or network system 116 (e.g., via communication network 114, etc.) and/or communicating information and/or data to merchant system 102, acquirer system 106, transaction service provider system 108, issuer system 110, user device 112, and/or network system 116 (e.g., via communication network 114, etc.). For example, payment gateway system 104 may include a computing device, such as a server, a group of servers, and/or other like devices. In some non-limiting embodiments or aspects, payment gateway system 104 is associated with a payment gateway as described herein.

In some embodiments, acquirer system 106 may include one or more devices capable of receiving information and/or data from merchant system 102, payment gateway system 104, transaction service provider system 108, issuer system 110, user device 112, and/or network system 116 (e.g., via communication network 114, etc.) and/or communicating information and/or data to merchant system 102, payment gateway system 104, transaction service provider system 108, issuer system 110, and/or user device 112 (e.g., via communication network 114, etc.). For example, acquirer system 106 may include a computing device, such as a server, a group of servers, and/or other like devices. In some non-limiting embodiments or aspects, acquirer system 106 may be associated with an acquirer as described herein.

In some embodiments, transaction service provider system 108 may include one or more devices capable of receiving information and/or data from merchant system 102, payment gateway system 104, acquirer system 106, issuer system 110, user device 112, and/or network system 116 (e.g., via communication network 114, etc.) and/or communicating information and/or data to merchant system 102, payment gateway system 104, acquirer system 106, issuer system 110, user device 112, and/or network system 116 (e.g., via communication network 114, etc.). For example, transaction service provider system 108 may include a computing device, such as a server (e.g., a transaction processing server, etc.), a group of servers, and/or other like devices. In some non-limiting embodiments or aspects, transaction service provider system 108 may be associated with a transaction service provider as described herein. In some non-limiting embodiments or aspects, transaction service provider system 108 may include and/or access one or more one or more internal and/or external databases including transaction data, and/or the like. In some embodiments, transaction service provider system 108 may include the catastrophic-event-aware fraud detection system described herein.

In some embodiments, issuer system 110 may include one or more devices capable of receiving information and/or data from merchant system 102, payment gateway system 104, acquirer system 106, transaction service provider system 108, user device 112, and/or network system 116 (e.g., via communication network 114, etc.) and/or communicating information and/or data to merchant system 102, payment gateway system 104, acquirer system 106, transaction service provider system 108, user device 112, and/or network system 116 (e.g., via communication network 114, etc.). For example, issuer system 110 may include a computing device, such as a server, a group of servers, and/or other like devices. In some non-limiting embodiments or aspects, issuer system 110 may be associated with an issuer institution as described herein. For example, issuer system 110 may be associated with an issuer institution that issued a payment account or instrument (e.g., a credit account, a debit account, a payment card, a credit card, a debit card, etc.) to a user (e.g., a user associated with user device 112, etc.).

In some non-limiting embodiments or aspects, transaction processing network 101 includes a plurality of systems in a communication path for processing a transaction. For example, transaction processing network 101 can include merchant system 102, payment gateway system 104, acquirer system 106, transaction service provider system 108, and/or issuer system 110 in a communication path (e.g., a communication path, a communication channel, a communication network, etc.) for processing an electronic payment transaction. As an example, transaction processing network 101 can process (e.g., initiate, conduct, authorize, etc.) an electronic payment transaction via the communication path between merchant system 102, payment gateway system 104, acquirer system 106, transaction service provider system 108, and/or issuer system 110.

In some embodiments, user device 112 may include one or more devices capable of receiving information and/or data from merchant system 102, payment gateway system 104, acquirer system 106, transaction service provider system 108, issuer system 110, and/or network system 116 (e.g., via communication network 114, etc.) and/or communicating information and/or data to merchant system 102, payment gateway system 104, acquirer system 106, transaction service provider system 108, issuer system 110, and/or network system 116 (e.g., via communication network 114, etc.). For example, user device 112 may include a client device and/or the like. In some non-limiting embodiments or aspects, user device 112 may be capable of receiving information (e.g., from merchant system 102, etc.) via a short range wireless communication connection (e.g., an NFC communication connection, an RFID communication connection, a Bluetooth® communication connection, and/or the like), and/or communicating information (e.g., to merchant system 102, etc.) via a short range wireless communication connection. In some non-limiting embodiments or aspects, user device 112 may include an application associated with user device 112, such as an application stored on user device 112, a mobile application (e.g., a mobile device application, a native application for a mobile device, a mobile cloud application for a mobile device, an electronic wallet application, a peer-to-peer payment transfer application, and/or the like) stored and/or executed on user device 112.

In some embodiments, communication network 114 may include one or more wired and/or wireless networks. For example, communication network 114 may include a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

Network system 116 may include one or more devices capable of receiving information and/or data from merchant system 102, payment gateway system 104, acquirer system 106, transaction service provider system 108, issuer system 110, and/or user device 112 (e.g., via communication network 114, etc.) and/or communicating information and/or data to merchant system 102, payment gateway system 104, acquirer system 106, transaction service provider system 108, issuer system 110, and/or user device 112 (e.g., via communication network 114, etc.). For example, network system 116 may include a computing device, such as a server, a group of servers, and/or other like devices. Furthermore, network system 116 may include servers or other computing devices that provide access to catastrophic event data (past or present) from, for example, social media resources, news resources, or other informational resources.

The number and arrangement of devices and systems shown in FIG. 1 is provided as an example. There may be additional devices and/or systems, fewer devices and/or systems, different devices and/or systems, or differently arranged devices and/or systems than those shown in FIG. 1. Furthermore, two or more devices and/or systems shown in FIG. 1 may be implemented within a single device and/or system, or a single device and/or system shown in FIG. 1 may be implemented as multiple, distributed devices and/or systems. Additionally or alternatively, a set of devices and/or systems (e.g., one or more devices or systems) of environment 100 may perform one or more functions described as being performed by another set of devices or systems of environment 100.

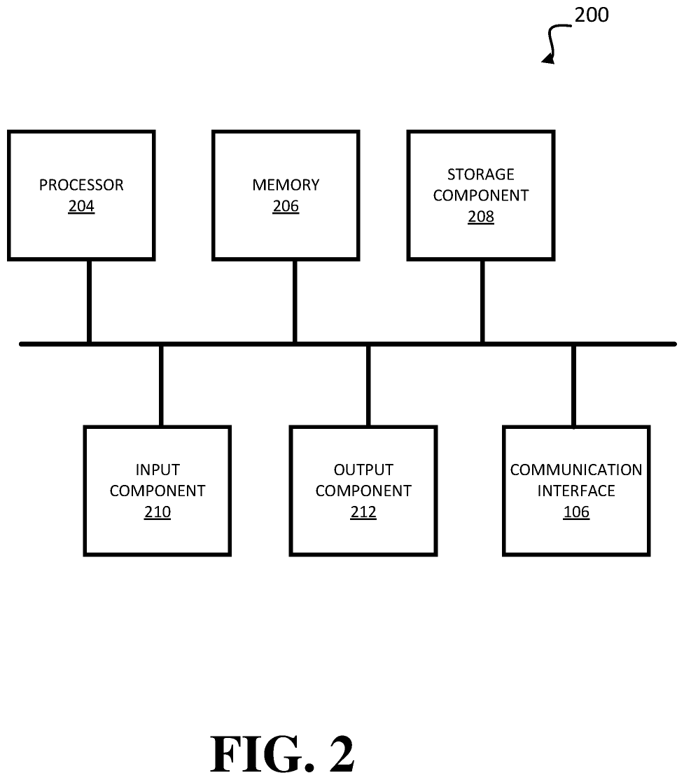

Referring now to FIG. 2, FIG. 2 is a diagram of example components of a device 200. Device 200 may correspond to one or more devices of transaction processing network 101, one or more devices of merchant system 102, one or more devices of payment gateway system 104, one or more devices of acquirer system 106, one or more devices of transaction service provider system 108, one or more devices of issuer system 110, user device 112 (e.g., one or more devices of a system of user device 112, etc.), and/or one or more devices of communication network 114. In some non-limiting embodiments or aspects, one or more devices of transaction processing network 101, one or more devices of merchant system 102, one or more devices of payment gateway system 104, one or more devices of acquirer system 106, one or more devices of transaction service provider system 108, one or more devices of issuer system 110, user device 112 (e.g., one or more devices of a system of user device 112, etc.), and/or one or more devices of communication network 114 can include at least one device 200 and/or at least one component of device 200. As shown in FIG. 2, device 200 may include a bus 202, a processor 204, memory 206, a storage component 208, an input component 210, an output component 212, and a communication interface 214.

In some embodiments, bus 202 may include a component that permits communication among the components of device 200. In some non-limiting embodiments or aspects, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

In some embodiments, software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

Memory 206 and/or storage component 208 may include data storage or one or more data structures (e.g., a database, etc.). Device 200 may be capable of receiving information from, storing information in, communicating information to, or searching information stored in the data storage or one or more data structures in memory 206 and/or storage component 208. For example, transaction service provider system 108 may include and/or access one or more internal and/or external databases that store transaction data associated with transactions processed and/or being processed in transaction processing network 101 (e.g., prior or historical transactions processed via transaction service provider system 108, etc.) and/or outside of transaction processing network 101, and/or the like.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

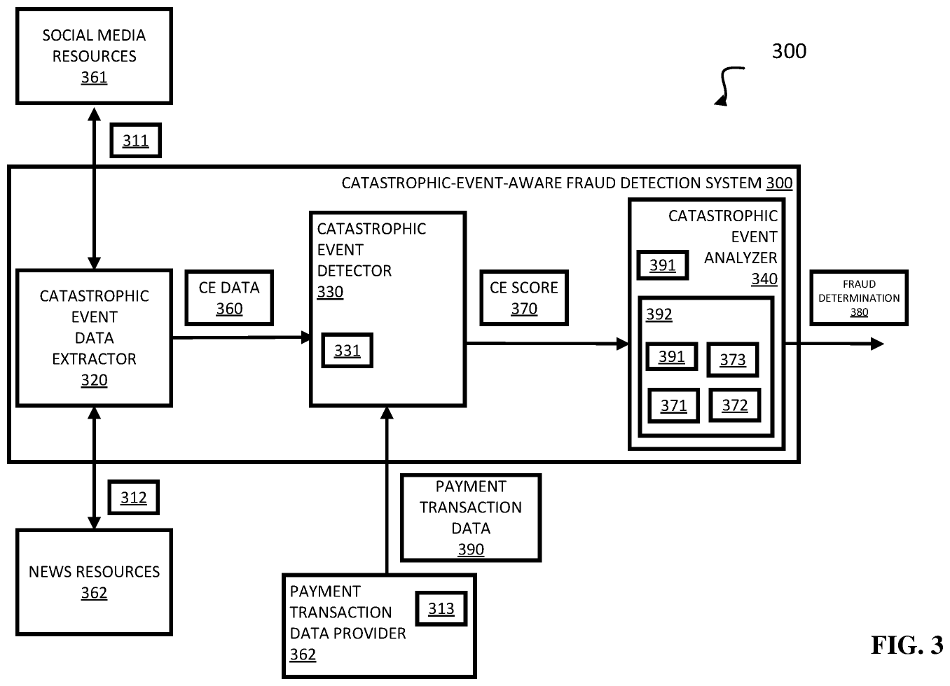

Referring now to FIG. 3, FIG. 3 is a diagram of example components of a catastrophic-event-aware fraud detection system 300 in accordance with some embodiments. In some embodiments, the catastrophic-event-aware fraud detection system 300 includes a catastrophic event data extractor 320, a catastrophic event detector 330, and a catastrophic event analyzer 340. In some embodiments, the catastrophic event data extractor 320 is coupled to catastrophic event data extractor 320 and catastrophic event analyzer 340 is coupled to catastrophic event detector 330. In some embodiments, catastrophic-event-aware fraud detection system 300 may be referred to as a catastrophic-event-based fraud detection system. In some embodiments, catastrophic event data extractor 320, catastrophic event detector 330, and catastrophic event analyzer 340 may be, for example, software and/or hardware components configured to perform the operations described herein.

In some embodiments, in order for catastrophic-event-aware fraud detection system 300 to determine whether payment transaction 350 is fraudulent, catastrophic-event-aware fraud detection system 300 utilizes the catastrophic event detector 330 to generate a catastrophic event score 370. In some embodiments, the catastrophic event score 370 serves as an indicator of a catastrophic event that is used to determine whether to adjust a fraud rule 391 to a catastrophic-event-based fraud rule 392. In addition, the catastrophic event score 370 is used in catastrophic-event-based fraud rule 392 to determine whether a payment transaction is fraudulent. In some embodiments, a catastrophic event is, for example, an event or force of nature that has catastrophic consequences, such as, an earthquake, a flood, a terrorist attack, a forest fire, a hurricane, a tornado, a tsunami, a volcanic eruption, a severe snowstorm, or some other catastrophic natural or man-made event.

In some embodiments, the catastrophic event detector 330 uses a catastrophic event detection machine learning model 331 to generate the catastrophic event score 370. The catastrophic event detection machine learning model 331 may be, for example, an Auto Regressive Integrated Moving Average (ARIMA), a Random Forest Regressor (RF), an Extreme Gradient Boosting Regressor (XGBT), a Gradient Boosting Regressor (GBT), a Facebook Prophet Library (FbPro), or the like. In some embodiments, the selection of a machine learning model for use as the catastrophic event detection machine learning model 331 is based on assessment of a root mean square error (RMSE) that is used to evaluate the performance of the catastrophic event detection machine learning model 331.

Initially, in order for the catastrophic event detector 330 to generate the catastrophic event score 370, the catastrophic event detection machine learning model 331 is trained by catastrophic-event-aware fraud detection system 300 to recognize catastrophic events by assessing historical catastrophic event data. In some embodiments, in order to train the catastrophic event detection machine learning model 331, catastrophic event data extractor 320 extracts historical catastrophic event data 311 from social media resources 361 and/or historical catastrophic event data 312 from news resources 362. In some embodiments, the historical catastrophic event data 311 and the historical catastrophic event data 312 include historical data related to catastrophic events that have occurred previously and that have been extracted from at least one of a social media resource 361 (such as, for example, social media applications) or news resource 362 (such as, for example, news media applications). In some embodiments, the social media resource 361 may be one or more social networking applications (e.g., Facebook®, TwitterTM, MySpaceTM, LinkedlnTM, etc.). In some embodiments, the news resource 362 may be, for example, websites such as weather.com, National Oceanic and Atmospheric Administration (NOAA), The New York Times, NPR News, Bloomberg, CNN, ABC News, CNBC, Huffington Post, BBC News, Reuters, The New York Times, USA Today, The Washington Post, the Los Angeles Times, etc. In some embodiments, the historical catastrophic event data may be extracted from any other resource similar to those described herein that generate historical catastrophic event data.

In some embodiments, after extracting the historical catastrophic event data 311 from social media resources 361 and the historical catastrophic event data 312 from news resource 362, catastrophic event detector 330 translates the historical catastrophic event data into machine learning feature form as catastrophic event data 360. For example, in some embodiments, catastrophic event data extractor 320 translates and categorizes the catastrophic event data 360 in such a manner that enables catastrophic event detector 330 to generate the catastrophic event score 370. In some embodiments, for example, catastrophic event data extractor 320 extracts and translates the catastrophic event data such that verbiage indicative of a catastrophic event, verbiage indicative of a start time of a catastrophic event, verbiage indicative of an end time of a catastrophic event, verbiage indicative of a geographic location of a catastrophic event, and verbiage indicative of a severity of the catastrophic event are included in the catastrophic event data 360. In some embodiments, the catastrophic event data may also be translated such that statistical information, such as, for example, a number of instances a catastrophic event is mentioned in a social media resource 361 and/or new resource 362, a number of “likes” of the catastrophic event, a number of times the geographic location of the catastrophic event is mentioned, etc., are included in the catastrophic event data 360.

In some embodiments, for example, catastrophic event data extractor 320 scans news resource 362 and extracts language in a statement provided by the news resource 362 that states, “A hurricane is scheduled to commence in Miami, Fla. on Aug. 5, 2024, and end Aug. 10, 2024. Please be advised.”. In some embodiments, catastrophic event data extractor 320 translates and categorizes the language of the statement into catastrophic event data 360 in a catastrophic event type category, a catastrophic event start time category, a catastrophic event end time category, a catastrophic event geographical location category, and a catastrophic event severity type category. In some embodiments, after translating the historical catastrophic event data, catastrophic event data extractor 320 provides the translated catastrophic event data 360 to catastrophic event detector 330 to train catastrophic event detection machine learning model 331.

Similarly, in some embodiments, payment transaction data provider 362 extracts catastrophic event historical payment transaction data 313 from archives of historical customer payment transactions collected by a transaction service provider, such as, for example, Visa® or some other transaction service provider. In some embodiments, payment transaction data provider 362 translates historical payment transaction data 313 into machine learning feature form as payment transaction data 390 for use by catastrophic event detector 330. In some embodiments, after translating the historical payment transaction data 313 to payment transaction data 390, payment transaction data provider 362 provides the payment transaction data 390 to catastrophic event detector 330 to train catastrophic event detection machine learning model 331.

In some embodiments, catastrophic event detector 330 receives the catastrophic event data 360 and payment transaction data 390 and uses a machine learning training application to train a machine learning algorithm to output the catastrophic event detection machine learning model 331. In some embodiments, the catastrophic event detection machine learning model 331 output by the machine learning training application is trained to generate the catastrophic event score 370. In some embodiments, as stated previously, the catastrophic event score 370 is a score that serves as an indicator of a catastrophic event (e.g., whether a catastrophic event is occurring or going to occur in the future). In some embodiments, in addition to training the catastrophic event detection machine learning model 331 to generate the catastrophic event score 370, the catastrophic event detection machine learning model 331 is trained to generate a start date of the catastrophic event, an end date of the catastrophic event, a geographic location of the catastrophic event, and a severity of the catastrophic event.

In some embodiments, the catastrophic event detection machine learning model 331 is trained to generate the catastrophic event score 370, the start date of the catastrophic event, the end date of the catastrophic event, geographic location of the catastrophic event, and severity of the catastrophic event by learning from patterns in the training data (e.g., catastrophic event data 360 and payment transaction data 390) that map the variables indicative of the catastrophic event (e.g., type of event, start date of event, end date of event, geographic location of event) to the target answer (e.g., the catastrophic event score 370).

In some embodiments, after the catastrophic event detection machine learning model 331 is trained to generate the catastrophic event score 370, the start date of the catastrophic event, the end date of the catastrophic event, the geographic location of the catastrophic event, and the severity of the catastrophic event, the catastrophic event detection machine learning model 331 is used as a prediction model to predict whether a catastrophic event is occurring or going to occur based on real-time catastrophic event data 360 and real-time payment transaction data 390. In some embodiments, the real-time catastrophic event data 360 and the real-time payment transaction data 390 are provided to catastrophic event detector 330 from catastrophic event data extractor 320 and payment transaction data provider 362, respectively. That is, in some embodiments, in addition to being configured to extract historical catastrophic event data from social media resources 361 and news resources 362, and historical payment transaction data from payment transaction data provide 362, catastrophic event data extractor 320 and payment transaction data service provider 362 are configured to continuously extract and ingest real-time catastrophic event data from social media resources 361 and news resources 362 , and real-time payment transaction data from payment transaction data provide 362. In some embodiments, the real-time catastrophic event data and the real-time payment transaction data are provided to catastrophic event detector 330 as catastrophic event data 360 and payment transaction data 390, respectively. In some embodiments, the catastrophic event data 360 and the payment transaction data 390 are utilized by catastrophic event detector 330 during the catastrophic event prediction process of catastrophic-event-aware fraud detection system 300.

In some embodiments, the catastrophic event detector 330 continuously receives real-time catastrophic event data 360 from catastrophic event data extractor 320 and real-time payment transaction data 390 from payment transaction data provider 362 and makes a prediction about whether a catastrophic event is occurring or going to occur. In some embodiments, using the catastrophic event prediction capabilities of catastrophic event detection machine learning model 331, when the catastrophic event detection machine learning model 331 determines that the verbiage or verbiage patterns of real-time catastrophic event data 360 and real-time payment transaction data 390 are indicative of a catastrophic event, the catastrophic event detector 330 assigns the catastrophic event score 370 to the catastrophic event. In some embodiments, for example, catastrophic event detector 330 may assign catastrophic event score 370 with a numerical value less than or equal to seventy-five for a catastrophic event and a numerical value greater than seventy-five when there is not a catastrophic event or the severity of the catastrophic event is such that there is not a need to adjust fraud rule 391. In some embodiments, the catastrophic event detector 330 provides the resulting catastrophic event score 370, the start date of the catastrophic event, the end date of the catastrophic event, the geographical location of the catastrophic event, and severity of the catastrophic event, to catastrophic event analyzer 340.

In some embodiments, catastrophic event analyzer 340 receives the catastrophic event score 370, the start date of the catastrophic event, the end date of the catastrophic event, the geographical location of the catastrophic event, and the severity of the catastrophic event from catastrophic event detector 330 and determines whether to adjust a fraud rule 391 to a catastrophic-event-based fraud rule 392. In some embodiments, for example, when the catastrophic event score 370 is less than or equal to a fraud rule adjustment threshold 389, the catastrophic event analyzer 340 adjusts the fraud rule 391 to include catastrophic event parameters, such as, for example, a catastrophic event threshold 371, a catastrophic-event-related-merchant category code 373, and a catastrophic event location 372. In some embodiments, the catastrophic event location 372 is the geographic location of the catastrophic event. In some embodiments, the catastrophic-event-related-merchant category code 373 is a merchant category code that has been designated by catastrophic-event-aware fraud detection system 300 as essential to the catastrophic event. In some embodiments, the catastrophic event threshold 371 is a threshold used to determine whether to decline or approve a payment transaction based on the catastrophic event score 370. In some embodiments, when the catastrophic event score 370 is greater than the fraud rule adjustment threshold 389, the catastrophic event analyzer 340 does not adjust the fraud rule 391 to include the catastrophic event parameters.

An example fraud rule 391 that is adjusted or not adjusted by the catastrophic event analyzer 340 based on the catastrophic event score 370 is depicted below:

if riskscore>risc_score_threshold and country_code!=issuer_country

then decline transaction

where riskscore is a score indicative of a fraud risk of the payment transaction, the risc_score_threshold is a threshold used to evaluated the riskscore, the country_code is a country code of the country associated with the payment card, and issuer_country is a country associated with the issuer of the payment card used in the payment transaction. In some embodiments, the example fraud rule 391 declines an attempt to purchase merchandise when the risk score, calculated according to a predetermined algorithm using one or more predetermined parameters, exceeds a predetermined threshold, and the country code is not the country code of the issuer country.

In some embodiments, catastrophic event analyzer 340 adjusts fraud rule 391 by adding the catastrophic event parameters (e.g., the catastrophic event threshold 371, the catastrophic-event-related-merchant category code 373 (CMCC 373), and the catastrophic event location 372) to the fraud rule 391 to generate catastrophic-event-based fraud rule 392.

An example catastrophic-event-based fraud rule 392 that has been adjusted from fraud rule 391 by the catastrophic event analyzer 340 is shown below:

if (catastrophic_event_score>catatstrophic_event_threshold AND

MCC!=CMCC AND transaction_location!=catastrophic_event_location) AND

if riskscore>riskscore_threshold and country_code!=issuer_country

then decline transaction

where catastrophic_event_score is the catastrophic event score output by the catastrophic event detector 330, the catatstrophic_event_threshold is the threshold used to approve the catastrophic_event_score, the catastrophic_event_location is the geographic location of the catastrophic event, the CMCC is the merchant category code deemed essential to the catastrophic event, riskscore is the score indicative of the risk of the payment transaction, the riskscore_threshold is the threshold used to evaluated the riskscore, the country_code is the country code of the country associated with the payment card, and issuer_country is the country associated with the issuer of payment card.

In some embodiments, the adjusted catastrophic-event-based fraud rule 392 is used to approve a payment transaction when the catastrophic event score 370, calculated using catastrophic event detection machine learning model 331 in catastrophic event detector 330, is below or equal to catastrophic event threshold 371, and a merchant category code associated with the payment transaction is equal to the catastrophic-event-related-merchant category code 373, and a risk score, calculated according to a predetermined algorithm using one or more predetermined parameters, is below or equal to a predetermined threshold, and the country code is the country code of the issuer country. In some embodiments, by approving payment transactions using the adjusted catastrophic-event-based fraud rule 392 that would have normally been declined using fraud rule 391, customers of financial institutions are more likely to have access to much needed necessities during catastrophic events.

Thus, adjusting fraud rule 391 to include the catastrophic event threshold 371, the catastrophic-event-related-merchant category code 373, and the catastrophic event location 372, improves upon existing fraud detection systems by allowing issuers to suppress fraud decline decisions for certain catastrophic-event-related-merchant category codes during catastrophic events, thereby alleviating painful false declines for certain catastrophic-event-related-merchant category codes.

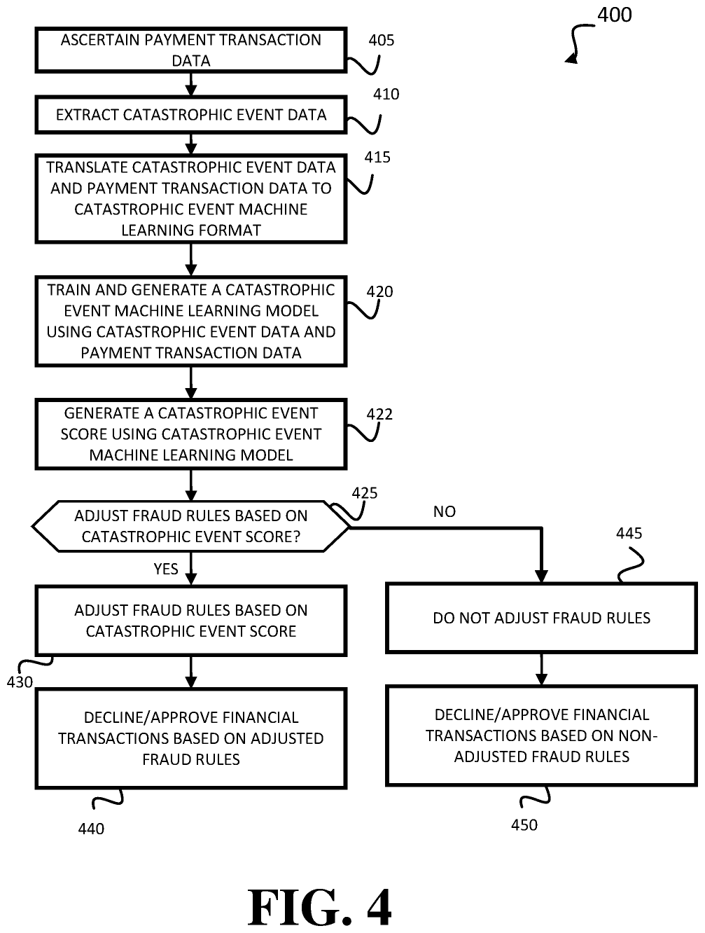

Referring now to FIG. 4, FIG. 4 is a flowchart of non-limiting embodiments or aspects of a process 400 for catastrophic-event-based fraud detection. In some non-limiting embodiments or aspects, one or more of the steps of process 400 may be performed (e.g., completely, partially, etc.) by catastrophic-event-aware fraud detection system 300 in transaction service provider system 108 (e.g., one or more devices of transaction service provider system 108). In some non-limiting embodiments or aspects, one or more of the steps of process 400 may be performed (e.g., completely, partially, etc.) by another device or a group of devices separate from or including transaction service provider system 108, such as merchant system 102 (e.g., one or more devices of merchant system 102), payment gateway system 104 (e.g., one or more devices of payment gateway system 104), acquirer system 106 (e.g., one or more devices of acquirer system 106), issuer system 110 (e.g., one or more devices of issuer system 110), and/or user device 112 (e.g., one or more devices of a system of user device 112).

As shown in FIG. 4, with reference to FIGS. 1-3, at step 405, process 400 includes ascertaining transaction data (e.g., payment transaction data 390) from payment transaction data provider 362. For example, catastrophic event detector 330 of transaction service provider system 108 may ascertain historical payment transaction data for previous payment transactions from payment transaction data provided 362. In some embodiments, catastrophic event detector 330 of transaction service provider system 108 may ascertain payment transaction data for a payment transaction currently being processed. As an example, transaction service provider system 108 may receive transaction data associated with a plurality of transactions. In some non-limiting embodiments or aspects, transaction data may include parameters associated with a transaction, such as an account identifier (e.g., a PAN, etc.), a transaction amount, a transaction date and/or time, a type of products and/or services associated with the transaction, a conversion rate of currency, a type of currency, a merchant type, a merchant name, a merchant location, a merchant, a merchant category group (MCG), a merchant category code (MCC), an AA score, a card acceptor identifier, a card acceptor country/state/region, and/or the like. In such an example, MCGs may include general categories under which MCCs fall, such as Travel, Lodging, Dining and Entertainment, Vehicle Expenses, Office Services and Merchandise, Cash Advance, Other, and/or the like. In such an example, an MCC is a four-digit number listed in ISO 18245 for retail financial services used to classify a business by the types of goods or services it provides.

In some non-limiting embodiments, at step 410, catastrophic event data extractor 320 extracts catastrophic event data 115, which may be, for example, real-time catastrophic event data for prediction purposes or historical catastrophic event data (e.g., historical catastrophic event data 311 and/or historical catastrophic event data 312) from social media resources 361 and/or news resources 362 for training purposes.

In some non-limiting embodiments, at step 415, catastrophic event data extractor 320 translates catastrophic event data 115 to machine learning feature form (e.g., catastrophic event data 360) and payment transaction data provider 362 translates historical payment transaction data 313 to machine learning form (e.g., payment transaction data 390).

In some non-limiting embodiments, at step 420, catastrophic event detector 330 trains and generates catastrophic event detection machine learning model 331 using catastrophic event data 360 and payment transaction data 390.

In some non-limiting embodiments, at step 422, in addition to generating the start date of the catastrophic event, the end date of the catastrophic event, the geographic location of the catastrophic event, and the severity of the catastrophic event, catastrophic event detector 330 utilizes the catastrophic event detection machine learning model 331 to generate catastrophic event score 370. In some embodiments, catastrophic event detection machine learning model 331 utilizes the catastrophic event data 360 and the payment transaction data 390 to generate catastrophic event score 370.

In some non-limiting embodiments, at step 425, catastrophic event analyzer 340 determines whether to adjust fraud rule 391 based on an assessment of the catastrophic event score 370. In some embodiments, at step 445, when, based on an assessment of the catastrophic event score 370, catastrophic event analyzer 340 determines not to adjust the fraud rule 391, catastrophic event analyzer 340 does not adjust the fraud rule 391 and proceeds to step 450. At step 450, catastrophic event analyzer 340 declines or approves payment transactions based on the non-adjusted fraud rule 391.

In some embodiments, at step 430, when, based on an assessment of the catastrophic event score 370, catastrophic event analyzer 340 determines to adjust the fraud rule 391, catastrophic event analyzer 340 adjusts the fraud rule 391 based on the catastrophic event score 370. In some embodiments, catastrophic event analyzer 340 adjusts the fraud rule 391 by including catastrophic event parameters, such as, for example, a catastrophic event threshold 371, a catastrophic-event-related-merchant category code 373, and a catastrophic event location 372. At step 440, catastrophic event analyzer 340 declines or approves payment transactions based on adjusted fraud rule, e.g., catastrophic-event-based fraud rule 392.

In some embodiments, a computer-implemented method includes receiving, with at least one processor, payment transaction data; extracting, using the at least one processor, catastrophic event data from a network; generating, with the at least one processor, a catastrophic event score based on the payment transaction data and the catastrophic event data; and adjusting a financial fraud rule by adding a catastrophic event threshold to the financial fraud rule that utilizes the catastrophic event score to determine whether a financial transaction is fraudulent. In some embodiments of the computer-implemented method, the catastrophic event data includes data related to a catastrophic event that is extracted from at least one of a social media application or news application. In some embodiments, the computer-implemented method includes determining, with at least one processor, a start date of the catastrophic event and a location of the catastrophic event based on the catastrophic event data. In some embodiments of the computer-implemented method, the start date of the catastrophic event and the location of the catastrophic event are used in combination with the catastrophic event score to determine, with at least one processor, whether to decline or approve the financial transaction. In some embodiments, the computer-implemented method includes refining the financial fraud rule to account for catastrophic-event-related-merchant category code types. In some embodiments of the computer-implemented method, in response to utilizing the refined financial fraud rule, the financial transaction is deemed not fraudulent when the financial transaction is associated with the catastrophic-event-related-merchant category code types. In some embodiments of the computer-implemented method, the catastrophic-event-related-merchant category code types include merchant category codes that correspond to merchant categories that relate to the catastrophic event. In some embodiments of the computer-implemented method, in response to determining that the financial transaction is a catastrophic event related transaction, providing, with at least one processor, a notification to an issuer system to allow the financial transaction to occur.

In some embodiments, a computing system includes a catastrophic event data extractor; a catastrophic event detector coupled to the catastrophic event data extractor; and a catastrophic event analyzer coupled to the catastrophic event detector, wherein based on a catastrophic event analysis of payment transaction data and catastrophic event data extracted by the catastrophic event detector, the catastrophic event analyzer dynamically adjusts a financial fraud rule by adding a catastrophic event threshold to the financial fraud rule that utilizes the catastrophic event score to determine whether a financial transaction fraudulent. In some embodiments of the computing system, the catastrophic event data includes data related to a catastrophic event that is extracted from at least one of a social media application or news application. In some embodiments of the computing system, a start date of the catastrophic event and a location of the catastrophic event is determined by the catastrophic event analyzer based on the catastrophic event data. In some embodiments of the computing system, the start date of the catastrophic event and the location of the catastrophic event are used in combination with the catastrophic event score to determine, at the catastrophic event analyzer, whether to decline or approve the financial transaction. In some embodiments of the computing system, the financial fraud rule is further refined at the catastrophic event analyzer to account for catastrophic-event-related-merchant category code types. In some embodiments of the computing system, in response to utilizing the refined financial fraud rule, the financial transaction is deemed not fraudulent when the financial transaction is associated with the catastrophic-event-related-merchant category code types. In some embodiments of the computing system, the catastrophic-event-related-merchant category code types include merchant category codes that correspond to merchant categories that relate to the catastrophic event.

In some embodiments, a computer program product includes at least one non-transitory computer-readable medium including program instructions that, when executed by at least one processor, cause the at least one processor to: receive payment transaction data; extract catastrophic event data from a network; generate a catastrophic event score based on the payment transaction data and the catastrophic event data; and adjust a financial fraud rule by adding a catastrophic event threshold to the financial fraud rule that utilizes the catastrophic event score to determine whether a financial transaction fraudulent. In some embodiments of the computer program product, the catastrophic event data includes data related to a catastrophic event that is extracted from at least one of a social media application or news application. In some embodiments of the computer program product, with at least one processor, a start date of the catastrophic event and a location of the catastrophic event is determined based on the catastrophic event data. In some embodiments of the computer program product, the start date of the catastrophic event and the location of the catastrophic event are used in combination with the catastrophic event score to determine, with at least one processor, to decline or approve the financial transaction. In some embodiments of the computer program product, the financial fraud rule is refined to account for catastrophic-event-related-merchant category code types.

What is claimed is:

1. A computer-implemented method, comprising:
receiving, with at least one processor, payment transaction data;
extracting, using the at least one processor, catastrophic event data from a network;
generating, with the at least one processor, a catastrophic event score based on the payment transaction data and the catastrophic event data; and
adjusting a financial fraud rule by adding a catastrophic event threshold to the financial fraud rule that utilizes the catastrophic event score to determine whether a financial transaction is fraudulent.

2. The computer-implemented method of claim 1, wherein:
the catastrophic event data includes data related to a catastrophic event that is extracted from at least one of a social media application or news application.

3. The computer-implemented method of claim 2, further comprising:
determining, with at least one processor, a start date of the catastrophic event and a location of the catastrophic event based on the catastrophic event data.

4. The computer-implemented method of claim 3, wherein:
the start date of the catastrophic event and the location of the catastrophic event are used in combination with the catastrophic event score to determine, with at least one processor, whether to decline or approve the financial transaction.

5. The computer-implemented method of claim 4, further comprising:
refining the financial fraud rule to account for catastrophic-event-related-merchant category code types.

6. The computer-implemented method of claim 5, further comprising:
in response to utilizing the refined financial fraud rule, the financial transaction is deemed not fraudulent when the financial transaction is associated with the catastrophic-event-related-merchant category code types.

7. The computer-implemented method of claim 6, wherein:
the catastrophic-event-related-merchant category code types include merchant category codes that correspond to merchant categories that relate to the catastrophic event.

8. The computer-implemented method of claim 7, wherein:
in response to determining that the financial transaction is a catastrophic event related transaction, providing, with at least one processor, a notification to an issuer system to allow the financial transaction to occur.

9. A computing system, comprising:
a catastrophic event data extractor;
a catastrophic event detector coupled to the catastrophic event data extractor; and
a catastrophic event analyzer coupled to the catastrophic event detector, wherein based on a catastrophic event analysis of payment transaction data and catastrophic event data extracted by the catastrophic event detector, the catastrophic event analyzer dynamically adjusts a financial fraud rule by adding a catastrophic event threshold to the financial fraud rule that utilizes the catastrophic event score to determine whether a financial transaction fraudulent.

10. The computing system of claim 9, wherein:
the catastrophic event data includes data related to a catastrophic event that is extracted from at least one of a social media application or news application.

11. The computing system of claim 10, wherein:
a start date of the catastrophic event and a location of the catastrophic event is determined by the catastrophic event analyzer based on the catastrophic event data.

12. The computing system of claim 11, wherein:
the start date of the catastrophic event and the location of the catastrophic event are used in combination with the catastrophic event score to determine, at the catastrophic event analyzer, whether to decline or approve the financial transaction.

13. The computing system of claim 12, wherein:
the financial fraud rule is further refined at the catastrophic event analyzer to account for catastrophic-event-related-merchant category code types.

14. The computing system of claim 13, wherein:
in response to utilizing the refined financial fraud rule, the financial transaction is deemed not fraudulent when the financial transaction is associated with the catastrophic-event-related-merchant category code types.

15. The computing system of claim 14, wherein:
the catastrophic-event-related-merchant category code types include merchant category codes that correspond to merchant categories that relate to the catastrophic event.

16. A computer program product comprising at least one non-transitory computer-readable medium including program instructions that, when executed by at least one processor, cause the at least one processor to:
receive payment transaction data;
extract catastrophic event data from a network;
generate a catastrophic event score based on the payment transaction data and the catastrophic event data; and
adjust a financial fraud rule by adding a catastrophic event threshold to the financial fraud rule that utilizes the catastrophic event score to determine whether a financial transaction fraudulent.

17. The computer program product of claim 16, wherein:
the catastrophic event data includes data related to a catastrophic event that is extracted from at least one of a social media application or news application.

18. The computer program product of claim 17, wherein:
with at least one processor, a start date of the catastrophic event and a location of the catastrophic event is determined based on the catastrophic event data.

19. The computer program product of claim 18, wherein:
the start date of the catastrophic event and the location of the catastrophic event are used in combination with the catastrophic event score to determine, with at least one processor, to decline or approve the financial transaction.

20. The computer program product of claim 19, wherein:
the financial fraud rule is refined to account for catastrophic-event-related-merchant category code types.
